(19) United States
(12) Patent Application Publication
(10) Pub. No.: US 2007/0140135 A1
(43) Pub. Date: Jun. 21, 2007

(54) Methods and systems for providing performance testing for private networks

(75) Inventor: Scott K. Sheppard, Decatur, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation, Wilmington, DE (US)

(21) Appl. No.: 11/300,755

(22) Filed: Dec. 15, 2005

(51) Int. Cl. H04J 1/16

(52) U.S. Cl. 370/250; 370/241

(57) ABSTRACT

Systems and methods are disclosed for providing performance testing for private networks. The disclosed systems and methods may include connecting a management virtual private network with a customer virtual private network, the management virtual private network and the customer virtual private network are configured to recognize each other's presence. Furthermore, the disclosed systems and methods may include using the management virtual private network to test the performance of a communication network. The communication network includes the management virtual private network and the customer virtual private network. In addition, the disclosed systems and methods may include reporting the performance testing results.

### RELATED APPLICATION

Related U.S. patent application Ser. No. ______, filed on even date herewith in the name of Chandu Gudipalley and entitled “METHODS AND SYSTEMS FOR PROVIDING OUTAGE NOTIFICATION FOR PRIVATE NETWORKS,” assigned to the assignee of the present application, is hereby incorporated by reference.

### BACKGROUND OF THE INVENTION

I. Field of the Invention

The present invention generally relates to methods and systems for providing performance testing for private networks. More particularly, the present invention relates to providing performance testing for virtual private networks without dedicating, for example, a device to the tested virtual private network.

II. Background Information

A virtual private network (VPN) is a network that is configured within a public network (e.g. a service provider's network or the Internet) in order to take advantage of the economies of scale and management facilities of large networks. VPNs are widely used by enterprises to create wide area networks (WANs) that span large geographic areas, to provide site-to-site connections to branch offices, and to allow mobile users to dial up their enterprise's local area network (“LAN”). In other words, a VPN is a private network that uses a public network to connect remote sites or users together. Instead of using only dedicated connections, such as leased lines, a VPN uses “virtual” connections routed through a public network from an enterprise's private network to a remote site or user.

Service providers provide networking services to customers according to service level agreements (SLA). Consequently, service providers take measurements on their networks in order to ensure service is provided to the customer at least at the level defined by the SLA. Furthermore, these customers have networks comprising one or more virtual routing and forwarding networks (VRFs), the functional portion of a VPN including customer premise equipment (CPE). Virtual routing and forwarding is a part of memory carved out of a router to support the routing tables associated with a VPN. Currently, service providers cannot make active measurements to CPE that are supported by a VRF. Further, to support out-of-region CPE devices, there is no method to manage the CPE nor to gather performance measurements.

Taking performance measurements on CPE in a VPN is problematic because normally, a VPN is a closed private network. That is, unless a device is a part of the VPN, it cannot communicate with any device within the VPN. This privacy level is one reason for VPNs' popularity. This poses a network performance testing problem, however. For example, if the VPN's performance is to be measured from a singe test point (or multiple test points), then a device controlled by the service provider needs to be dedicated to that VPN only. This strategy is cost prohibitive. For example, a service provider seeking to test the VPN's performance needs to maintain a device in all tested VPNs. Due to the large number of VPNs on the service provider's network, maintaining a device in all tested VPNs would be a costly solution.

In view of the foregoing, there is a need for methods and systems for providing performance testing for private networks more optimally. Furthermore, there is a need for providing performance testing for virtual private networks without dedicating, for example, a device to a tested virtual private network.

### SUMMARY OF THE INVENTION

Consistent with embodiments of the present invention, systems and methods are disclosed for providing performance testing for virtual private networks.

In accordance with one embodiment, a method for providing performance testing comprises connecting a management virtual private network with a customer virtual private network, the management virtual private network and the customer virtual private network configured to recognize each other's presence, using the management virtual private network to test the performance of a communication network, the communication network including the management virtual private network and the customer virtual private network, and reporting results of the performance testing.

According to another embodiment, a system for providing performance testing comprises a memory storage for maintaining a database and a processing unit coupled to the memory storage, wherein the processing unit is operative to connect a management virtual private network with a customer virtual private network, the management virtual private network and the customer virtual private network configured to recognize each other's presence, use the management virtual private network to test the performance of a communication network, the communication network including the management virtual private network and the customer virtual private network, and report results of the performance testing.

In accordance with yet another embodiment, a computer-readable medium which stores a set of instructions which when executed performs a method for providing performance testing for virtual private networks, the method executed by the set of instructions comprising connecting a management virtual private network with a customer virtual private network, the management virtual private network and the customer virtual private network configured to recognize each other's presence, using the management virtual private network to test the performance of a communication network, the communication network including the management virtual private network and the customer virtual private network, and reporting results of the performance testing.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary communication system consistent with an embodiment of the present invention;

FIG. 2 is a block diagram of an exemplary performance processor consistent with an embodiment of the present invention; and

FIG. 3 is a flow chart of an exemplary method for providing performance testing consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Systems and methods consistent with embodiments of the present invention provide performance testing for private networks. Normally, a VPN is a closed customer network within a larger service provider's network. For example, unless a device is a part of the VPN, it cannot communicate with any device within the VPN. This poses a network performance testing problem, for example, if the VPN's performance is to be measured from a singe test point, then a device controlled by the service provider needs to be dedicated to the tested VPN. Due to the large number of VPNs on the service provider's network, however, maintaining a device in all VPNs to be tested would be cost prohibitive.

Consistent with embodiments of the invention, the service provider can provide a management VPN (MVPN) that provides limited access to devices within customer VPNs within the service provider's network. For example, a small group of test devices included in the MVPN can access customer premises equipment (CPE) devices in customer VPNs (CVPNs) within the service provider's network. Consequently, the CVPNs within the service provider's network participate in two VPNs, their own CVPN and the MVPN.

In order to support SLAs, service providers take network measurements. Consistent with embodiments of the present invention, service providers may measure network performance across access lines of any type within or without a VRF. This process is also agnostic regarding whether the CPE is within or without a territory service by the service provider. Conventional processes cannot function within a VRF since the VRF is a private network. In the past, to address this problem with conventional processes, dedicated equipment was needed for each VRF. If a provider supports thousands of VRF's, this solution would be cost prohibitive. Consistent with embodiment of the invention, the MVPN is provided, and in conjunction with a performance software module and service provider probe processes, performance measurements can be supported from one or more devices to any CPE in any CVPN

(i.e. VRF.)

Consistent with embodiment of the invention, the MVPN can perform the following functions: i) measure network performance (such as, but not limited to, delay round trip, delay one way, jitter round trip, jitter one way, packet loss round trip, packet loss one way, packets out of sequence, packets late arrival, MOS scores, “R” values) across any layer 2 access method (e.g. Frame Relay, Ethernet, ATM); ii) measure network performance within a customer VRF from a single or more than one device that is not directly a part of the customer VRF; iii) measure network performance either within the service provider territory or across another carriers network using an inter-provider VPN model; and iv) measure end-to-end network performance from CPE to core, in the core, and across another access line without needing to run a specific test from a customer's first CPE to a customer's second CPE.

An embodiment consistent with the invention comprises a system for providing performance testing for virtual private networks. The system comprises a memory storage for maintaining a database and a processing unit coupled to the memory storage. The processing unit is operative to connect a management virtual private network with a customer virtual private network, the management virtual private network and the customer virtual private network are configured to recognize each other's presence. Moreover, the processing unit is operative to use the management virtual private network to test the performance of a communication network, the communication network including the management virtual private network and the customer virtual private network. In addition the processing unit is operative to report the performance testing results.

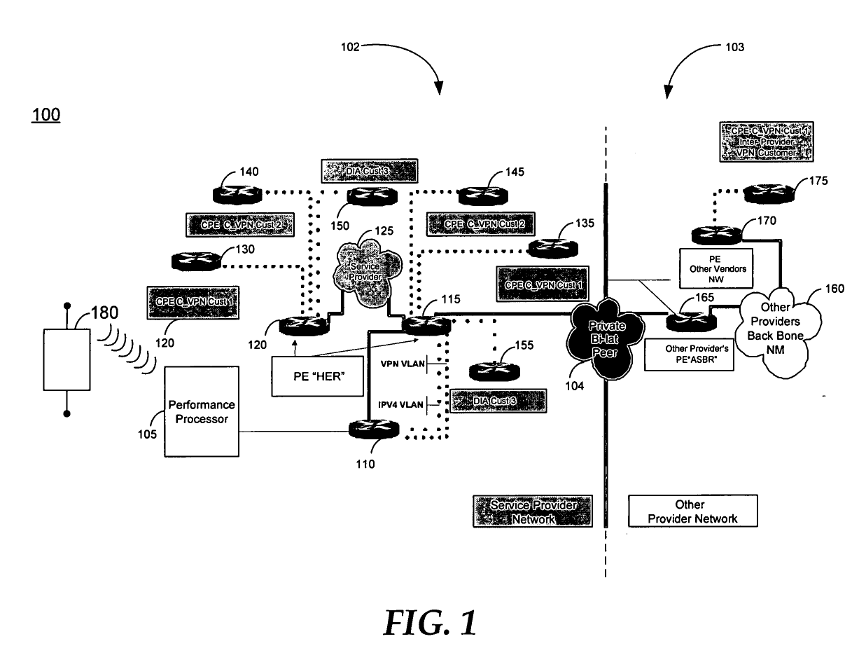

Consistent with an embodiment of the present invention, the aforementioned memory, processing unit, and other components are implemented in a communications system, such as an exemplary communications system 100 of FIG. 1. Any suitable combination of hardware, software and/or firmware may be used to implement the memory, processing unit, or other components. By way of example, the memory, processing unit, or other components is implemented with a performance processor 105, in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which the features and principles of the present invention may be implemented. As illustrated in the block diagram of FIG. 1, system 100 includes a service provider network 102 and other provider network 103 connected through a private bi-lateral peer 104. Service provider network 102 includes performance processor 105, a shadow router 110, a first provider edge (PE) router 115, a second PE router 120, and a service provider backbone 125.

Furthermore, CPE, including, for example, routers are connected to service provider network 102. For example, service provider network 102 includes first customer CPEs 130 and 135, second customer CPEs 140 and 145, and third customer CPEs 150 and 155. First customer CPEs 130 and 135 are associated as a first VPN and second customer CPEs 140 and 145 are associated with a second VPN. Third customer CPEs 150 and 155 are not associated with a VPN.

Other provider network 103 includes an other provider backbone 160 and other provider PE's 165 and 170. In addition, other provider network 103 includes an additional first customer CPE 175. First customer CPEs 130, 135, and 175 may be associated as an “interprovider VPN”, which comprises an interaction between service provider network 102 and other service provider network 103. An interprovider VPN is used to support sharing VPN information across two or more carrier's networks. This allows the service provider to support customer VPN networks, for example, outside the service provider's franchise or region.

Shadow router 110 is connected to first PE router 115 via a single “Gig E” interface. This way, shadow router 110 can use any operating system needed to support new functionality without posing a threat to the core network interior gateway protocol (IGP) or border gateway protocol (BGP) function. The physical Gig E interface has three virtual local areas networks (VLANs) associated with it: i) one for IPV4 Internet traffic VLAN 330; ii) one for VPN-V4 traffic (VPN, VLAN 340); and iii) one for internal service provider traffic (VLAN 350).

First PE router 115 is peered to a virtual router redundancy (VRR)-VPN route reflector so first PE router 115 has information about all MVPN customer routes.

These routes are filtered to prevent unneeded customer specific routes from entering first PE router 115's routing table. Only /32 management loop back addresses assigned to customer CPEs will be allowed in first PE router 115's management VPN VRF table (example 10.255.247.7./32). All other PE routers in service provider network 102 communicate with shadow router 110 via service provider backbone 125.

First PE router 115 and second PE router 120 provide performance measurement access, for example, to: i) first customer CPEs 130 and 135 via WAN interface addresses proximal to the CPE; ii) in region VPN customers (i.e. second customer CPEs 140 and 145); and 3) in and out-of-region customers using the MVPN (first customer CPEs 130 and 135 plus CPE 175.) Shadow router 110 can reach the CPE devices via static routes. Since all CPEs have management addresses derived from, for example, the 10.160.0.0/14 range. The static routes can be summarized to control access to sensitive routes.

To reach non-VPN CPEs such as associated with Dedicated Internet Access (DIA) routers, internal traffic VLAN 330 is provisioned between shadow router 110 and first PE router 115. This VLAN can support IPV4 addressing. Since each non-VPN managed CPE has no loopback interface, management performance traffic can be directed to the physical WAN interface proximal on the DIA CPE router. This, for example, is how simple network management protocol (SNMP) functions are performed conventionally. Each WAN address is assigned by the service provider from globally unique address space. Further, these addresses come from a central pool of addresses. Thus, these routes can also be summarized for management access from shadow router 110 located within system 100. CPEs belonging to service provider customers not within the service provider network 102 will be reached using the MVPN extended into other provider's network 103.

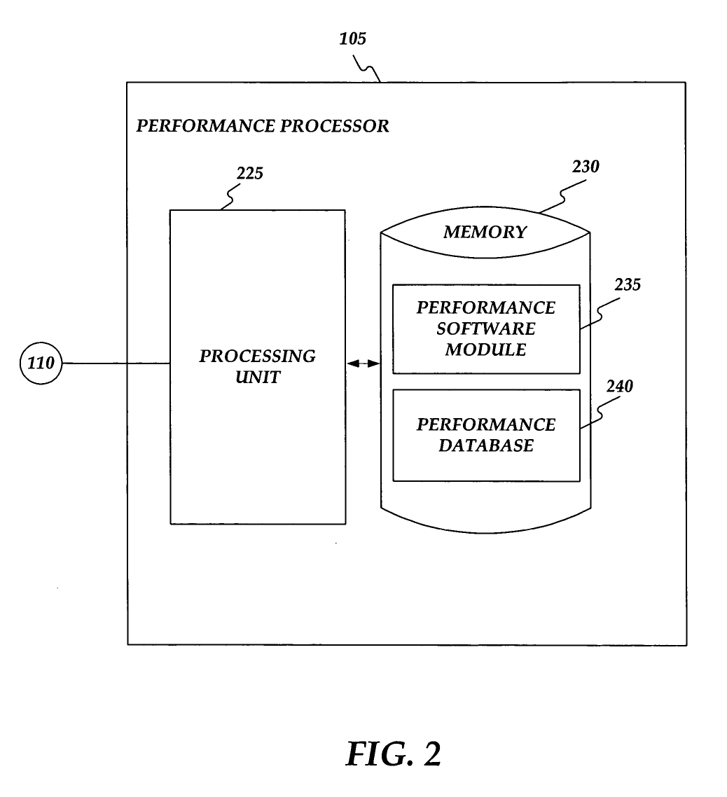

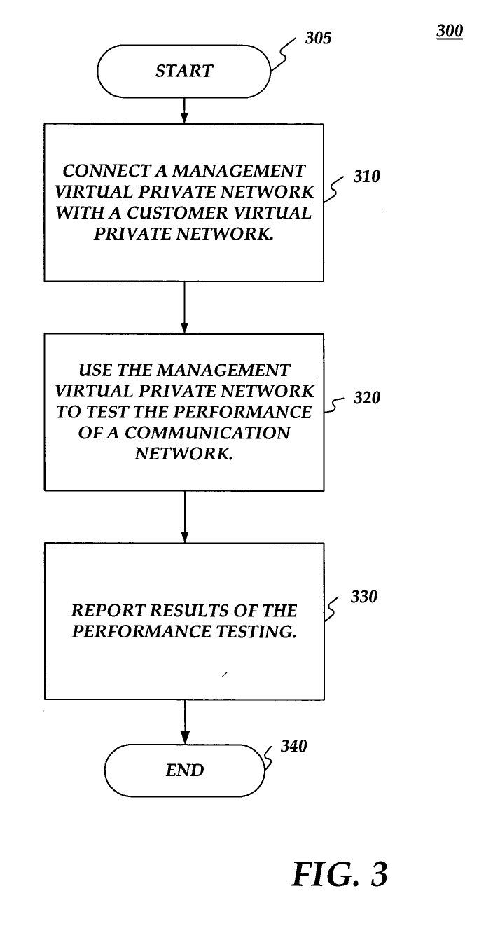

FIG. 2 shows performance processor 105 of FIG. 1 in more detail. As shown in FIG. 2, performance processor 105 includes a processing unit 225 and a memory 230. Memory 230 includes a performance software module 235 and a performance database 240. While executing on processing unit 225, performance software module 235 performs processes for providing performance testing of private networks, including, for example, one or more of the stages of method 300 described below with respect to FIG. 3.

Performance processor 105 (“the processor”) included in system 100 may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

In addition to utilizing a wire line communications system in system 100, a wireless communications system, or a combination of wire line and wireless may be utilized in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processor in the wireless environment can be any mobile terminal, such as the mobile terminals described above. Wireless data may include, but is not limited to, paging, text messaging, e-mail, Internet access and other specialized data applications specifically excluding or including voice transmission. For example, the processor may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

FIG. 3 is a flow chart setting forth the general stages involved in an exemplary method 300 consistent with an exemplary embodiment of the invention for providing performance testing using system 100 of FIG. 1. Exemplary ways to implement the stages of exemplary method 300 will be described in greater detail below. Exemplary method 300 begins at starting block 305 and proceeds to stage 310 where performance processor 105 communicates with a MVPN which in turn communicates to a CVPN. The MVPN and the CVPN are configured to recognize each other's presence. To accomplish this, as described below, the MVPN and the CVPN may use a routing protocol such as border gateway protocol (BGP.) BGP is a routing protocol that spans autonomous systems on, for example, the Internet.

A virtual routing and forwarding interface (VRF) is constructed for the MVPN. This management virtual routing and forwarding interface (MVRF) is constructed in PE router (120, 115, etc.). Then the MVRF is given a route descriptor. This router descriptor is unique to the router on which the MVRF resides (e.g. PE router 115 or 120, etc.). Next, the MVRF is given a route target. This MVRF route target is a series of numbers that defines a virtual routing and forwarding table (VRF). For example, in this MVRF route target, the export and import says for all the PE routers that are participating in this VRF (i.e. first PE router 115 and second PE router 120), exchange information with 65534 on it as illustrated in Table 1 below. That is, shadow router 115 or 120 may communicate that it has a number of routes and if any PE routers want to have them, they should look for RT (route target) 65534. Likewise, first PE router 115 and second PE router 120 are going to import data into their tables if they see data coming labeled with 65534.

TABLE 1

ip vrf BLS_MGT_VPN_001
rd A.B.C.D:E
export map REDIS_INTO_CUST
route-target export 6389:65534
route-target import 6389:65534
route-target import 6389:65532

For the customer CPE to be able to interact with shadow router 110, the CVPN needs to have knowledge of how to route to shadow router 110. Thus, the MVPN exports management routes to the CVPN. This route information sharing from the MVPN to a CVPN is called route redistribution.

For each CVPN on any given PE, selected management routes are imported into the CVPN. However, to redistribute management routes to CVPNs, more control may be used. This control is offered via the route-map REDIS_INTO_CUST as shown in Table 2. This route-map utilizes the prefix-list MGMT_TO_CUST. The prefixes included in this list include prefixes for all devices in the MVRF.

TABLE 2

route-map REDIS_INTO_CUST permit 10
match ip address prefix-list MGMT_TO_CUSTOMER
set extcommunity rt 6389:65533 additive

Letting the CVPN learn routes to the MVRF devices allows MVPN customer CPEs to communicate with shadow router 110 for information, for example, relating to link utilization, class utilization, etc., directly. The route map REDIS_INTO_CUST, as shown in Table 2, searches for a matching management prefix via the prefix list MGMT_TO_CUSTOMER and, if a match is found, it appends the extended community 6389:65533 onto that management prefix. This will then be imported into the CVPN.

From stage 310, where a PE (115, 120, etc.) participating in the management VPN connects the MVPN with the CVPN, exemplary method 300 advances to stage 320 where performance processor 105 uses the MVPN to test the performance of a communication network. The communication network includes the MVPN and the CVPN. Because the MVPN and the CVPN recognize each other, performance processor 105 (embedded in shadow router 110) can probe the service provider network even into the CVPNs. For example, consistent with embodiment of the invention, performance processor 105 executes performance software module 235 to perform any one or more of the following functions: i) measure network performance (delay round trip, delay one way, jitter round trip, jitter one way, packet loss round trip, packet loss one way, packets out of sequence) across any layer 2 access method (e.g. Frame Relay, Ethernet, ATM); ii) measure network performance within a CVRF from a single or more than one device that is not directly a part of the CVRF; iii) measure network performance either within the service provider territory or across another provider network using, for example, an inter-provider VPN model; and iv) measure end-to-end network performance from CPE to the service provider network core, core and across another access line without needing to run a specific test from a customer's first CPE to a customer's second CPE.

For example, the service provider may wish to measure performance from one point in system 100 to another in order to enforce, for example, a service level agreement between the customer and the service provider. The customer may expect a certain amount of performance from the service provider and may pay more money, per the service level agreement, for higher service levels. Using processor 105 as described above, the service provider measures the performance between first customer CPE 130 and service provider backbone 125 (i.e. piece A.) In addition, processor 105 can measure the performance of service provider backbone 125 (i.e. piece B). Furthermore, using processor 105, as described above, the service provider can measure the performance between second customer CPE 135 and service provider backbone 125 (i.e. piece C.) Taking all three (pieces A, B, and C), performance processor 105 measures “end-to-end” performance, for example, from first customer CPE 130, through service provider backbone 125, and through second customer CPE 135. In order to provide performance measurement, processor 105 may also utilize service assurance agent (SAA) available from CISCO SYSTEMS, INC. of San Jose, Calif.

Consistent with embodiments of the invention, system 100 can obtain current time data via a satellite 180 and provide the time to all devices in system 100 in order, for example, to provide better performance measurements. For example, shadow router 110 may provide to the CPE current and accurate timing information through service provider network 102.

Once performance processor 105 uses the management virtual private network to test the performance of a communication network in stage 320, exemplary method 300 continues to stage 330 where performance processor 105 reports results of the performance testing. For example, performance processor 105 gathers the performance information and sends it to a customer associated with the CVPN or to the service provider. After performance processor 105 reports results of the performance testing in stage 330, exemplary method 300 then ends at stage 340.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, these aspects may also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing performance testing, the method comprising:
connecting a management virtual private network with a customer virtual private network, the management virtual private network and the customer virtual private network configured to recognize each other's presence;
using the management virtual private network to test the performance of a communication network, the communication network including the management virtual private network and the customer virtual private network; and
reporting results of the performance testing.

2. The method of claim 1, wherein connecting the management virtual private network with the customer virtual private network further comprises:
configuring the customer virtual private network to learn management virtual private network routes; and
exporting customer virtual private network routes to the management virtual private network.

3. The method of claim 1, wherein using the management virtual private network to test the performance of the communication network further comprises measuring network performance comprising at least one of: delay round trip, delay one way, jitter round trip, jitter one way, packet loss round trip, packet loss one way, and packets out of sequence.

4. The method of claim 3, wherein measuring network performance further comprises measuring network performance across any layer 2 access method.

5. The method of claim 1, wherein connecting the management virtual private network with the customer virtual private network further comprises connecting the management virtual private network with the customer virtual private network wherein the customer virtual private network includes at least a first router located on a service provider network and a second router located on another service provider's network.

6. The method of claim 1, wherein using the management virtual private network to test the performance of the communication network further comprises measuring end-to-end communication network performance to and from customer premises equipment located in the customer virtual private network through a core of the communication network.

7. The method of claim 1, wherein using the management virtual private network to test the performance further comprises using the management virtual private network to provide current time information to the customer virtual private network.

8. A system for providing performance testing, the system comprising:
a memory storage for maintaining a database; and
a processing unit coupled to the memory storage, wherein the processing unit is operative to:
connect a management virtual private network with a customer virtual private network, the management virtual private network and the customer virtual private network configured to recognize each other's presence;
use the management virtual private network to test the performance of a communication network, the communication network including the management virtual private network and the customer virtual private network; and
report results of the performance testing.

9. The system of claim 8, wherein the processing unit being operative to connect the management virtual private network with the customer virtual private network further comprises the processing unit being operative to:
configure the customer virtual private network to learn management virtual private network routes; and
export customer virtual private network routes to the management virtual private network.

10. The system of claim 8, wherein the processing unit being operative to use the management virtual private network to test the performance of the communication network further comprises the processing unit being operative to measure network performance comprising at least one of: delay round trip, delay one way, jitter round trip, jitter one way, packet loss round trip, packet loss one way, and packets out of sequence.

11. The system of claim 10, wherein the processing unit being operative to measure network performance further comprises the processing unit being operative to measure network performance across any layer 2 access system.

12. The system of claim 8, wherein the processing unit being operative to connect the management virtual private network with the customer virtual private network further comprises the processing unit being operative to connect the management virtual private network with the customer virtual private network wherein the customer virtual private network includes at least a first router located on a service provider network and a second router located on another service provider's network.

13. The system of claim 8, wherein the processing unit being operative to use the management virtual private network to test the performance of the communication network further comprises the processing unit being operative to measure end-to-end communication network performance to and from customer premises equipment located in the customer virtual private network through a core of the communication network.

14. A computer-readable medium which stores a set of instructions which when executed performs a method for providing performance testing for virtual private networks, the method executed by the set of instructions comprising:
connecting a management virtual private network with a customer virtual private network, the management virtual private network and the customer virtual private network configured to recognize each other's presence;
using the management virtual private network to test the performance of a communication network, the communication network including the management virtual private network and the customer virtual private network; and
reporting results of the performance testing.

15. The computer-readable medium of claim 14, wherein connecting the management virtual private network with the customer virtual private network further comprises:
configuring the customer virtual private network to learn management virtual private network routes; and
exporting customer virtual private network routes to the management virtual private network.

16. The computer-readable medium of claim 14, wherein using the management virtual private network to test the performance of the communication network further comprises measuring network performance comprising at least one of: delay round trip, delay one way, jitter round trip, jitter one way, packet loss round trip, packet loss one way, and packets out of sequence.

17. The computer-readable medium of claim 16, wherein measuring network performance further comprises measuring network performance across any layer 2 access computer-readable medium.

18. The computer-readable medium of claim 14, wherein connecting the management virtual private network with the customer virtual private network further comprises connecting the management virtual private network with the customer virtual private network wherein the customer virtual private network includes at least a first router located on a service provider network and a second router located on another service provider's network.

19. The computer-readable medium of claim 14, wherein using the management virtual private network to test the performance of the communication network further comprises measuring end-to-end communication network performance to and from customer premises equipment located in the customer virtual private network through a core of the communication network.

20. The computer-readable medium of claim 14, wherein using the management virtual private network to test the performance further comprises using the management virtual private network to provide current time information to the customer virtual private network.
